(19) United States
(12) Patent Application Publication
(10) Pub. No.: US 2004/0169305 A1
(43) Pub. Date: Sep. 2, 2004

(54) Method for producting fibers prepeg that can be highly stressed

(76) Inventors: Horst-Dieter Rector, Linnich (DE); Johannes Frenken, Aachen (DE)

Correspondence Address: Purdue Law Offices, Suite B-2, 2735 N Holland-Sylvania Road, Toledo, OH, 43615-1844, US

(21) Appl. No.: 10/480,139

(22) PCT Filed: Mar. 17, 2003
(86) PCT No.: PCT/DE03/00849

(30) Foreign Application Priority Data
Mar. 15, 2002 (DE) 102 11 668.7

(51) Int. Cl. B32B 3/26

(52) U.S. Cl. 264/134

(57) ABSTRACT

The invention pertains to a method for producing heavy-duty yarn prepregs of glass fibers or aramide fibers or carbon fibers, wherein the fibers are soaked in a PTFE dispersion, subsequently conveyed through a nozzle and simultaneously pressure-impregnated, and wherein the air that is still situated between the individual filaments of the fibers is pressed out and the individual filaments are completely encased with PTFE and then dried. The objective of the invention consists of achieving an additional increase in the strength of the yarns, in particular, in the resistance to abrasion, with a method of this type.

The invention proposes that the narrowest cross section of the nozzle is 15-170% greater than the sum of the cross sections of the individual yarn filaments, and that the PTFE used for encasing the individual filaments is sintered out before the yarn is rolled up. An outlet attachment may be advantageously connected to the outlet end of the nozzle, wherein this outlet attachment forms a linear extension of the nozzle outlet end in the form of a guide channel, the profile of which corresponds to that of the nozzle outlet end.

The invention pertains to a method for producing heavy-duty yarn prepregs of glass fibers or aramide fibers or carbon fibers with a yarn thickness between 110 and 4080 dtex, wherein the fibers are soaked in a PTFE dispersion, subsequently conveyed through a nozzle and simultaneously pressure-impregnated, and wherein the air that is still situated between the individual filaments of the fibers is pressed out and the individual filaments are completely encased with PTFE and then dried.

The present invention is based on the objective of additionally increasing the strength of the yarns as well as of the textile products obtained thereof with a method of the initially cited type (PCT/DE 00/00833).

According to the invention, this objective is attained due to the fact that, when utilizing a nozzle without a cylindrical outlet attachment, the narrowest cross section of the nozzle is 15-170% greater than the sum of the cross sections of the individual yarn filaments, and due to the fact that the PTFE used for encasing the individual filaments is sintered out before the yarn is rolled up.

According to the invention, the small ratio between the nozzle cross section on one hand and the sum of the cross sections of the filaments used on the other hand results in yarns in which it is ensured that the individual filaments and their intermediate spaces are respectively encased and filled out with PTFE and that air bubbles are pressed out. Consequently, there exists no space for an undesirable admission of moisture into capillary spaces of the yarn.

According to the invention, an outlet attachment may be connected to the outlet end of the nozzle such that it forms a linear extension of the nozzle outlet end in the form of a guide channel, the profile of which corresponds to that of the nozzle outlet end.

In this case, the invention utilizes the known technical effect that the arrangement of an outlet attachment on the nozzle outlet end makes it possible to increase the nozzle efficiency, i.e., the effect of a nozzle with a smaller outlet cross section can be achieved by arranging such an outlet attachment on a nozzle. This effect is of particular importance if nozzles with a very small outlet cross sections are required which are associated with high manufacturing expenditures and subjected to a high degree of wear. In nozzles of this type, it also needs to be observed that even slight manufacturing tolerances have a significant effect on the material being conveyed through the nozzle. The utilization of an outlet attachment, in contrast, simplifies the manufacture and reduces the wear. In addition, the manufacturing tolerances are lowered and have less severe effects.

The invention proposes that the length of the outlet attachment is approximatively determined with the formula of Hagen-Poiseuille, according to which the following applies:

$$V = \frac{Π \cdot Δ p \cdot t \cdot {D}^{4}}{128 \cdot η \cdot L}$$

and, accordingly,

$$V \sim \frac{{D}^{4}}{L}$$

if the remaining factors are approximately constant.

The reference symbols used in this formula are

V: flow volume

Δp: differential pressure between nozzle inlet and nozzle outlet

D: hydraulic diameter of the nozzle

L: length of the outlet attachment

η: viscosity of the fluid

t: time.

The aforementioned formula also applies approximatively to impregnating nozzles, wherein it needs to be observed that filaments are also conveyed through the nozzle in addition to a fluid. The determining geometric factors in this formula are D=hydraulic diameter and L=length. If the other factors remain constant, the flow volume is approximately proportional to the ratio

$$V \sim \frac{{D}^{4}}{L} .$$

This means that, in theory, the same quantity of fluid is able to flow through a nozzle with twice the diameter and 16-times the length. For example, this means

$$\frac{{D}^{4}}{L} = \frac{{1}^{η}}{10} = \frac{{2}^{4}}{160} = 0.1 .$$

With respect to practical applications, this indicates that it may be advantageous to provide, in particular, very small nozzles for fine yarns with an outlet attachment. This makes it possible to operate with nozzles that have larger diameters such that, among other things, the insertion of yarns into the nozzles is simplified.

In the method according to the invention, the nozzle and the guide channel of the outlet attachment are formed by a round or cornered profile that is covered with a plate-shaped cover element such that a guide channel is formed between the plate-shaped cover element and the round or cornered profile. The cover element can be removed in order to insert a yarn. This makes the method feasible for practical applications or at least significantly simplifies the production of smaller yarn thicknesses.

The yarn emerging from the nozzle—with or without outlet attachment—has closed intermediate spaces and is composed of individual filaments that are encased with PTFE. The invention proposes that the yarn is sintered out before it is rolled up such that the yarn has superior strength properties, in particular, an excellent resistance to abrasion, during its subsequent additional processing. In this respect, it is advantageous that yarns of this type which are arranged on top of one another in a fabric do not lead to damages due to the completely encased individual filaments.

When utilizing a nozzle without a cylindrical outlet attachment, the invention proposes that the narrowest cross section of the nozzle is only 50-100% greater than the sum of the cross sections of the individual yarn filaments to be conveyed through the nozzle.

When utilizing a nozzle without a cylindrical outlet attachment and an impregnating dispersion with a concentration between 35 and 45 wt. %, the invention proposes that the cross section of the nozzle is 50-95% greater than the sum of the cross sections of the individual yarn filaments. If the dispersion has a concentration between 55 and 65 wt. %, the invention proposes that the cross section of the nozzle is 20-40% greater than the sum of the cross sections of the individual yarn filaments. If the impregnating dispersion has a concentration between 25 and 35 wt. %, the invention proposes a nozzle cross section that is 90-170% greater than the sum of the cross sections of the individual yarn filaments.

Examples of the method according to the invention are described below. The figures show:

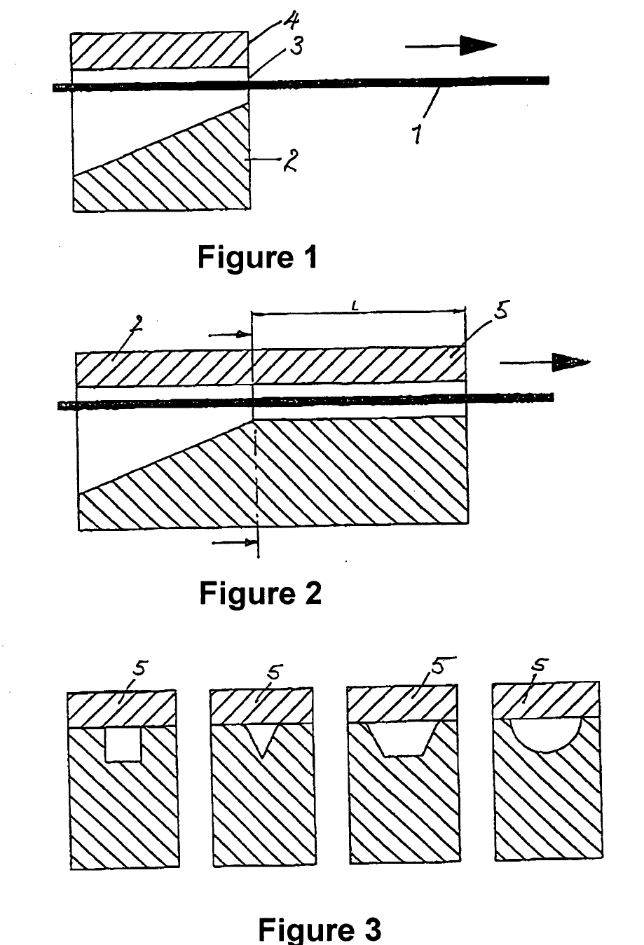

FIG. 1 a schematic sectional representation of a suitable nozzle for the method according to the invention;

FIG. 2 a schematic sectional representation of a suitable nozzle with outlet attachment for the method according to the invention, and

FIG. 3 a section through several profiles for the nozzle and the outlet attachment transverse to the transport direction.

In FIG. 1, the arrow symbolizes a yarn 1 that is conveyed through a nozzle 2 from the left toward the right, wherein the nozzle is tapered toward the right, i.e., toward its outlet end 3. The upper side 4 of the nozzle is covered with a plate-like cover element that can be removed in order to insert the yarn.

The embodiment shown in FIG. 2 merely differs from the embodiment according to FIG. 1 in that an outlet attachment 5 is connected to the nozzle 1, wherein said outlet attachment is identified by the reference symbol L and forms a linear extension of the outlet end of the nozzle 2. This outlet attachment extends linearly and has the same profile as the outlet end 3 of the nozzle 2. The nozzle 2 and the outlet attachment 5 may be realized integrally or consist of separate elements that can be aligned and directly connected to one another.

FIG. 3 shows sectional representations analogous to the section shown in FIG. 2, namely of four nozzle cross sections. These examples merely represent a selection of numerous conceivable profiles.

Three respective examples for carrying out the method according to the invention with glass fibers, aramide fibers and carbon fibers are listed in the enclosed table, wherein the three examples differ with respect to the concentration of the impregnating dispersion, as well as with respect to the PTFE content of the sintered yarn. A titer of 110 dtex (glass 1), 220 dtex (glass 2), 1360 dtex (glass 3), 800 dtex (carbon fiber) and 110 dtex (aramide) was used in all three examples. Accordingly, the sums of the filament cross sections correspond for the respective materials in all three examples.

It was determined that the titer and the sum of the filament cross sections require a significant number of different nozzle cross sections for the individual fiber materials in dependence on the respective concentration of the impregnating dispersion.

The value indicated in the table under the heading “nozzle cross section>sum of the filament cross sections” refers to the percentage, by which the respective nozzle cross section is greater than the sum of the filament cross sections. These columns clearly indicate that, in relation to the sum of the filament cross sections, the nozzle cross section needs to increase proportionally to the decrease in the concentration of the dispersion used for impregnating the filaments.

The four columns on the far right of the table indicate the ratio between the nozzle cross section and the sum of the filament cross sections in dependence on the length of the cylindrical outlet attachment. The column on the far left is based on an outlet attachment length zero, wherein the ensuing columns on the right side indicate the corresponding ratio for an outlet attachment length of 6 mm, 31 mm and 55 mm, respectively. This comparison makes it clear that the ratio between the nozzle cross section and the sum of the filaments increases if the sum of the filament cross sections remains the same. This means that the nozzle cross section can be enlarged as the length of the outlet attachment increases i.e., the wear of the nozzle can be reduced by increasing its cross section.

After passing through the nozzle that may or may not contain an outlet attachment, the yarns are sintered out and rolled up in this state.

The yarns are additionally processed in the form of weaving, knitting, plaiting, lacing or braiding the thusly obtained yarn prepregs. The resulting textile products can be calendered after this type of processing. The finished product is particularly suitable for tent canvases, transport covers or as a protection against heat and flames.

Examples:

| Concentration of the | % | 40 | | | | | | |
|---|---|---|---|---|---|---|---|---|
| dispersion | | | | | | | | |
| PTFE content of the | % | 20 | | | | | | |
| sintered yarn | | | | | Ratio between nozzle cross | | | |
| | | Sum of | | Nozzle cross | section and the sum of | | | |
| | | filament | | section > sum of | filament cross sections | | | |
| | | Cross | Nozzle cross | the filament cross | Length of the cylindrical | | | |
| | Titer | sections | section | sections | outlet attachement | | | |
| | dtx | mm² | mm² | % | 0 | 6 mm | 31 mm | 55 mm |
| Glass | 110 | 0.0042 | 0.0081 | 91.5 | 1.915 | 2.160 | 2.405 | 2.650 |
| Glass | 220 | 0.0085 | 0.0162 | 91.5 | 1.915 | 2.160 | 2.405 | 2.650 |
| Glass | 1360 | 0.0523 | 0.1002 | 91.5 | 1.915 | 2.160 | 2.405 | 2.650 |
| Carbon fiber | 800 | 0.0444 | 0.726 | 63.4 | 1.634 | 1.879 | 2.124 | 2.369 |
| Aramide | 110 | 0.0076 | 0.0115 | 51.1 | 1.511 | 1.756 | 2.000 | 2.245 |
| Concentration of the | % | 60 | | | | | | |
| dispersion | | | | | | | | |
| PTFE content of the | % | 10 | | | | | | |
| sintered yarn | | | | | Ratio between nozzle cross | | | |
| | | Sum of | | Nozzle cross | section and the sum of | | | |
| | | filament | | section > sum of | filament cross sections | | | |
| | | Cross | Nozzle cross | the filament cross | Length of the cylindrical | | | |
| | Titer | sections | section | sections | outlet attachment | | | |
| | dtx | mm² | mm² | % | 0 | 6 mm | 31 mm | 55 mm |
| Glass | 110 | 0.0042 | 0.0081 | 36.6 | 1.366 | 1.611 | 1.856 | 2.101 |
| Glass | 220 | 0.0085 | 0.0116 | 36.6 | 1.366 | 1.611 | 1.856 | 2.101 |
| Glass | 1360 | 0.0523 | 0.0714 | 36.6 | 1.366 | 1.611 | 1.856 | 2.101 |
| Carbon fiber | 800 | 0.0444 | 0.0557 | 25.3 | 1.253 | 1.498 | 1.743 | 1.988 |
| Aramide | 110 | 0.0076 | 0.0091 | 20.4 | 1.204 | 1.449 | 1.694 | 1.939 |
| Concentration of the | % | 30 | | | | | | |
| dispersion | | | | | | | | |
| PTFE content of the | % | 30 | | | | | | |
| sintered yarn | | | | | Ratio between nozzle cross | | | |
| | | Sum of | | Nozzle cross | section and the sum of | | | |
| | | filament | | section > sum of | filament cross sections | | | |
| | | Cross | Nozzle cross | the filament cross | Length of the cylindrical | | | |
| | Titer | sections | section | sections | outlet attachment | | | |
| | dtx | mm² | mm² | % | 0 | 6 mm | 31 mm | 55 mm |
| Glass | 110 | 0.0042 | 0.0081 | 166.3 | 2.663 | 2.908 | 3.153 | 3.398 |
| Glass | 220 | 0.0085 | 0.0225 | 166.3 | 2.663 | 2.908 | 3.153 | 3.398 |
| Glass | 1360 | 0.0523 | 0.1393 | 166.3 | 2.663 | 2.908 | 3.153 | 3.398 |
| Carbon fiber | 800 | 0.0444 | 0.0956 | 115.1 | 2.151 | 2.396 | 2.641 | 2.886 |
| Aramide | 110 | 0.0076 | 0.0146 | 92.8 | 1.928 | 2.172 | 2.417 | 2.662 |

1. A method for producing heavy-duty yarn prepregs of glass fibers or aramide fibers or carbon fibers with a yarn thickness between 110 and 4080 dtex, wherein the fibers are soaked in a PTFE dispersion, subsequently conveyed through a nozzle and simultaneously pressure-impregnated, and wherein the air that is still situated between the individual filaments of the fibers is pressed out and the individual filaments are completely encased with PTFE and then dried,
characterized in that
the smallest diameter of the nozzle used lies on its outlet end, wherein said diameter is 15-170% greater than the sum of the cross sections of the individual yarn filaments, and in that the PTFE used for encasing the individual filaments is sintered out before the yarn is rolled up.

2. The method according to claim 1, characterized in that an outlet attachment is connected to the outlet end of the nozzle, wherein said outlet attachment forms a linear extension of the nozzle outlet end in the form of a guide channel, the profile of which corresponds to that of the nozzle outlet end.

3. The method according to claim 2, characterized in that the length of the outlet attachment is approximatively determined with the formula of Hagen-Poiseuille, according to which the following applies:
$$V = \frac{Π \cdot Δ p \cdot t \cdot {D}^{4}}{128 \cdot η \cdot L}$$
and, accordingly,
$$V \sim \frac{{D}^{4}}{L}$$
if the remaining factors are approximately constant.

4. The method according to claim 2 or 3, characterized in that the nozzle and the guide channel of the outlet attachment are formed by a round or cornered profile that is covered with a plate-shaped cover element such that a guide channel is formed between the plate-shaped cover element and the round or cornered profile.

5. The method according to claim 1, characterized in that, when utilizing a nozzle without a cylindrical outlet attachment, the narrowest cross section of the nozzle is 50-100% greater than the sum of the cross sections of the individual yarn filaments.

6. The method according to claim 1, characterized in that, when utilizing a nozzle without a cylindrical outlet attachment and a 35-45 wt. % concentration of the impregnating dispersion, the cross section of the nozzle is 50-95% greater than the sum of the cross sections of the individual yarn filaments.

7. The method according to claim 1, characterized in that, when utilizing a nozzle without a cylindrical outlet attachment and a 55-65 wt. % concentration of the impregnating dispersion, the cross section of the nozzle is 20-40% greater than the sum of the cross sections of the individual yarn filaments.

8. The method according to claim 1, characterized in that, when utilizing a nozzle without a cylindrical outlet attachment and a 25-35 wt. % concentration of the impregnating dispersion, the cross section of the nozzle is 90-170% greater than the sum of the cross sections of the individual yarn filaments.
